(19) United States
(12) Patent Application Publication
(10) Pub. No.: US 2026/0254305 A1
(43) Pub. Date: Aug. 27, 2026

(54) A Motor and a Connecting Device for Connection of Stator Wires for the Motor

(71) Applicant: Siemens Aktiengesellschaft, München (DE)

(72) Inventors: Rui Chen, Nan Jing (CN); Ling Ling Zou, Nanjing (CN); Jian Qiang Zhu, Shenyang (CN); Yu Ting Wang, Nanjing (CN)

(73) Assignee: Siemens Aktiengesellschaft, München (DE)

(21) Appl. No.: 18/874,919

(22) PCT Filed: Jun. 16, 2022
(86) PCT No.: PCT/CN2022/099264

§ 371 Date: Dec. 13, 2024

(51) Int. Cl. H02K 3/50; H02K 1/16; H02K 3/02; H02K 3/34

(52) U.S. Cl. CPC H02K 3/50; H02K 1/16; H02K 3/02; H02K 3/34; H02K 2203/06; H02K 2203/09

(57) ABSTRACT

Various embodiments of the teachings herein include a connecting device for connection of stator wires for a motor. An example comprises: a supporting board including a chamber, a lower slot, and an upper slot, wherein the lower slot is configured to hold a first stator wire at a terminal section of the lower slot, the upper slot is configured to hold a second stator wire at a terminal section of the upper slot, and the first stator wire and second stator wire have an up and down layout in the chamber; and a mag mate to pierce the insulation of the first stator wire and the second stator wire and electrically connect the first stator wire to the second stator wire in the up and down layout.

### CROSS-REFERENCE TO RELATED APPLICATIONS

This application is a U.S. National Stage Application of International Application No. PCT/CN2022/099264 filed Jun. 16, 2022, which designates the United States of America, the contents of which are hereby incorporated by reference in their entirety.

### TECHNICAL FIELD

The present disclosure relates to motors. Various embodiments of the teachings herein include motors and connecting devices for connection of stator wires for the motor.

### BACKGROUND

Generally, a motor obtains rotational power by converting electrical energy into mechanical energy. A normal motor includes a stator and a rotor. An electromagnetic field is generated when current flows through the stator. Torque is generated so that the rotor rotates, and the rotational force of the rotor is transmitted to the rotating shaft, and the rotating shaft drives the load. For example, when used in a washing machine, the rotating shaft is connected to the drum of the washing machine to drive the drum.

On the other hand, the stator of the motor, which is connected to the stator wires, is connected to the internal power line from the outside to supply power to the stator wires, wherein the connector as a medium is called a mag mate. A supporting board is used to support the stator wires to be connected and the mag mate.

### SUMMARY

Teachings of the present disclosure include motors and connecting devices for connection of stator wires for the motor, providing an up and down layout of the stator wires to be connected and improving the reliability of the connection of the stator wires for the motor. For example, some embodiments include a connecting device for connection of stator wires for a motor, comprising: a supporting board comprises a chamber; a lower slot and an upper slot, wherein the lower slot configured to hold a first stator wire and the first stator wire is at a terminal section of the lower slot, the upper slot configured to hold a second stator wire and the second stator wire is at a terminal section of the upper slot, and the first stator wire has an up and down layout with the second stator wire in the chamber; and a mag mate configured to cut the insulation of the first stator wire and the second stator wire broken and to make the first stator wire and the second stator wire connected in the up and down layout.

In some embodiments, the width of the terminal section of the lower slot and the terminal section of the upper slot is the maximum diameter of the stator wires for a series of motors.

In some embodiments, the lower slot has a first direction and the upper slot has a second direction, the first direction and the second direction of same directions or opposite directions.

In some embodiments, the terminal section of the lower slot is aligned vertically with the terminal section of the upper slot.

In some embodiments, the chamber configured to support the mag mate with the first stator wire and the second stator wire.

In some embodiments, the chamber further comprises: an inlet panel configured to contain inlet spacing, for the first stator wire and the second stator wire entering into the chamber; an outlet panel configured to contain outlet spacing, for the first stator wire and the second stator wire exiting the chamber; and a surface protrusion;

In some embodiments, the lower slot and the upper slot locate in the inlet panel or the outlet panel.

In some embodiments, the surface protrusion configured to support the first stator wire and the second stator wire to be connected in the chamber.

In some embodiments, the first stator wire enters the chamber before the second stator wire.

In some embodiments, the first stator wire and the second stator wire are copper (Cu) or aluminum (Al) wire coated with insulation.

In some embodiments, the mag mate is made by mental.

As another example, some embodiments include a motor comprising: a stator core, configured to hold stator windings in place; a housing, configured to hold the stator assembly; a supporting board comprises a chamber; a lower slot and an upper slot, wherein the lower slot configured to hold a first stator wire and the first stator wire is at a terminal section of the lower slot, the upper slot configured to hold a second stator wire and the second stator wire is at a terminal section of the upper slot, and the first stator wire has an up and down layout with the second stator wire in the chamber; and a mag mate, configured to cut the insulation of the first stator wire and the second stator wire broken and to make the first stator wire and the second stator wire connected in the up and down layout.

In some embodiments, the width of the terminal section of the lower slot and the terminal section of the upper slot is the maximum diameter of the stator wires for a series of motors.

In some embodiments, the lower slot has a first direction and the upper slot has a second direction, the first direction and the second direction are of same directions or opposite directions.

In some embodiments, the terminal section of the lower slot is aligned vertically with the terminal section of the upper slot. In some embodiments, the chamber configured to support the mag mate with the first stator wire and the second stator wire.

In some embodiments, the chamber further comprises: an inlet panel configured to contain inlet spacing, for the first stator wire and the second stator wire entering into the chamber; an outlet panel configured to contain outlet spacing, for the first stator wire and the second stator wire exiting the chamber; and a surface protrusion.

In some embodiments, the lower slot and the upper slot locate in the inlet panel or the outlet panel.

In some embodiments, the surface protrusion configured to support the first stator wire and the second stator wire to be connected in the chamber.

In some embodiments, the first stator wire enters the chamber before the second stator wire.

In some embodiments, the first stator wire and the second stator wire are copper (Cu) or aluminum (Al) wire coated with insulation.

In some embodiments, the mag mate is made by mental.

### BRIEF DESCRIPTION OF THE DRAWINGS

The above-mentioned characteristics, technical features, advantages and implementations of the teachings of the present disclosure will be further described below in a clear and easy-to-understand manner through the description of the preferred embodiments in conjunction with the accompanying drawings, wherein:

FIG. 1 is a perspective top view of an example scenario incorporating teachings of the present disclosure;

FIG. 2 is an example application scenario for a V-slot design incorporating teachings of the present disclosure;

FIG. 3 is another example of the V-slot design and a mag mate incorporating teachings of the present disclosure;

FIG. 4 is an example connecting device incorporating teachings of the present disclosure;

FIG. 5 is another example connecting device incorporating teachings of the present disclosure;

FIG. 6 is another example connecting device incorporating teachings of the present disclosure; and

FIG. 7 is another example connecting device incorporating teachings of the present disclosure.

Reference Numbers:

| | | |
|---|---|---|
| 100: supporting board | 101: chamber | 102: stator wires |
| 103: outlet panel | 104: inlet panel | 105: inlet spacing |
| 106: outlet spacing | 107: surface protrusion | 200: supporting board |
| 201: first stator wire | 202: second stator wire | 203: V-slot |
| 300: supporting board | 301: Mag-Mate | 302: chamber |
| 303: first stator wire | 304: second stator wire | 305: inlet spacing |
| 306: outlet spacing | 400: supporting board | 401: first stator wire |
| 402: second stator wire | 403: lower slot | 404: upper slot |
| 500: supporting board | 501: first stator wire | 502: second stator wire |
| 503: lower slot | 504: upper slot | 600: inlet panel |
| 601: outlet panel | 602: first stator wire | 603: second stator wire |
| 604: lower slot | 605: upper slot | 701: motor |
| 702: stator cores | 703: stator housing | 704: supporting boards |
| 705: mag mates | | |

### DETAILED DESCRIPTION

Various embodiments of the teachings herein include a connecting device for connection of stator wires for a motor is disclosed. An example connecting device includes: a supporting board comprises a chamber; a lower slot and an upper slot, wherein the lower slot configured to hold a first stator wire and the first stator wire is at a terminal section of the lower slot, the upper slot configured to hold a second stator wire and the second stator wire is at a terminal section of the upper slot, and the first stator wire has an up and down layout with the second stator wire in the chamber; and a mag mate configured to cut the insulation of the first stator wire and the second stator wire broken and to make the first stator wire and the second stator wire connected in the up and down layout.

Some embodiments include a motor comprising: a stator core, configured to hold stator windings in place; a housing, configured to hold the stator assembly; a supporting board comprises a chamber; a lower slot and an upper slot, wherein the lower slot configured to hold a first stator wire and the first stator wire is at a terminal section of the lower slot, the upper slot configured to hold a second stator wire and the second stator wire is at a terminal section of the upper slot, and the first stator wire has an up and down layout with the second stator wire in the chamber; and a mag mate, configured to cut the insulation of the first stator wire and the second stator wire broken and to make the first stator wire and the second stator wire connected in the up and down layout.

The two slots design provides an up and down layout of the first stator wire and the second stator wire to be connected. Specifically, the lower slot configured to hold the first stator wire and the first stator wire is at the terminal section of the lower slot and the upper slot configured to hold the second stator wire and the second stator wire is at the terminal section of the upper slot. Therefore, the terminals of the two slots can hold the first stator wire and the second stator wire separately and keep the first stator wire and the second stator wire in an up and down layout. This two slots design improves the reliability of the connection of the stator wires for the motor.

Based on the teachings of the present disclosure, the width of the terminal section of the lower slot and the terminal section of the upper slot is the maximum diameter of the stator wires for a series of motors. The connecting device is suitable for the connection of a series of stator wires with different diameters, thus reduces the production costs. Example embodiments of the teachings herein are described in more detail below with reference to the accompanying drawings. While certain embodiments of the present disclosure are shown in the drawings, it should be understood that the present disclosure may be embodied in various forms and should not be construed as limited to the embodiments set forth herein, but rather are provided for the purpose of A more thorough and complete understanding of the present disclosure. It should be understood that the drawings and embodiments of the present disclosure are only for exemplary purposes and are not intended to limit the protection scope of the present disclosure.

As used herein, the term “including” and variations thereof are open-ended inclusions, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions of other terms will be given in the description below. It should be noted that the concepts such as “first” and “second” mentioned in the present disclosure are only used to distinguish different devices, modules or units, and are not used to limit the order of functions performed by these devices, modules or units or interdependence.

It should be noted that the modifications of “a” and “a plurality” mentioned in the present disclosure are illustrative rather than restrictive, and those skilled in the art should understand that unless the context clearly indicates otherwise, they should be understood as “one or a plurality of”. multiple”. The names of messages or information exchanged between multiple devices in the embodiments of the present disclosure are only used for illustrative purposes and are not used to limit the scope of these messages or information.

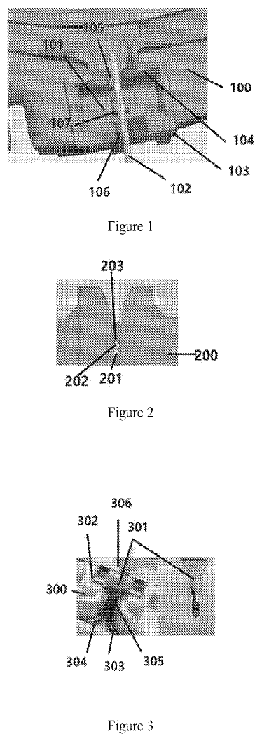

FIG. 1 shows a perspective view of an example application scenario of a supporting board 100 incorporating teachings of the present disclosure. The supporting board 100 includes a chamber 101, an outlet panel 103, an inlet panel 104, inlet spacing 105, outlet spacing 106 and a surface protrusion 107. The stator wires 102 enter the chamber 101 through the inlet spacing 105 from the inlet panel 104 side and exit the chamber 101 through the outlet spacing 106 from the outlet panel 103 side. Additionally, the surface protrusion 107 supports the stator wires 102 to be connected when applying a mag mate to cut the insulation of the stator wires broken and to make the stator wires connected. Optionally, there is no limitation on the shape of the surface protrusion 107. The details of the mag mate will be illustrated in the later sections.

In some embodiments, the supporting board 100 can be made of plastic, wood, glass or other similar materials. The stator wires 102 can be made of copper (Cu) or aluminum (Al) wire coated with insulation.

The continuous working of the motor needs the reliable connection of the conductive wires of the stator. The supporting board 100 is applied to support the stator wires 102 and provides an up and down layout of the stator wires 102 to be connected. In the prior art, a V-slot design on the supporting board is applied to make sure that the stator wires can keep an up and down layout. When pressing the mag mate, the insulation of stator wires can be cut broken as completely as possible to achieve a stable connection.

FIG. 2 is an example application scenario of an embodiment of a V-slot design incorporating teachings of the present disclosure. The design of the V-slot 203 on the supporting board 200 is applied to make sure that a first stator wire 201 and a second stator wire 202 always keep an up and down layout. When pressing the mag mate, the insulation of the first stator wire 201 and the second stator wire 202 can be cut broken as completely as possible to achieve a stable connection.

However, with one V-slot holding two stator wires, there is no terminal section to hold the second stator wire 202, therefore, the up and down layout of the first stator wire 201 and the second stator wire 202 cannot be guaranteed. When pressing the mag mate, the second stator wire 202 might not be able to have stable connection with the first stator wire 201 in the V-slot. In this circumstance, the reliability of the connection of the stator wires for the motor cannot be guaranteed.

Furthermore, in the same series of a product, different types of motor have stator wires with different diameters. If only apply one size of V-slot 203 to match all different stator wires, the up and down layout of the stator wires to be connected cannot be guaranteed. Furthermore, the stator wires with greater diameters might not be able to be inserted into the V-slot 203, while insulation of the stator wires with smaller diameters might not be able to be completely cut by the mag mate.

To make sure that the first stator wire 201 and the second stator wire 202 always keep the up and down layout, a solution is to produce a series of supporting board 200 with V-slot 203 of different dimensions. One size of V-slot is corresponding to one type of stator wires with a specific diameter. Therefore, the production of various supporting boards is required.

To reduce the manufacturing costs of the supporting boards while maintaining the reliability of the connection of the stator wires for the motor, it is necessary to design a type of supporting board that can be used to hold and keep the up and down layout of the stator wires with different diameters.

FIG. 3 is another example connecting device and an example mag mate incorporating teachings of the present disclosure. The connecting device includes a supporting board 300 and a mag mate 301. The mag mate 301 is made of metal.

A chamber 302 in the supporting board 300 is used to support the mag mate 301 with a first stator wire 303 and a second stator wire 304. The stator wires 303 enter the chamber 302 through inlet spacing 305 and exit the chamber 302 through outlet spacing 306. Additionally, the first stator wire 303 and the second stator wire 304 must be inserted into the terminal sections of the inlet spacing 305 and the outlet spacing 306. The mag mate 301 is used to cut the insulation of the first stator wire 303 and the second stator wire 304 broken and to make the first stator wire 303 and the second stator wire 304 connected in the up and down layout.

Specifically, when pressing the mag mate 301, the insulation of the first stator wire 303 and the second stator wire 304 can be cut broken as completely as possible to achieve a stable connection.

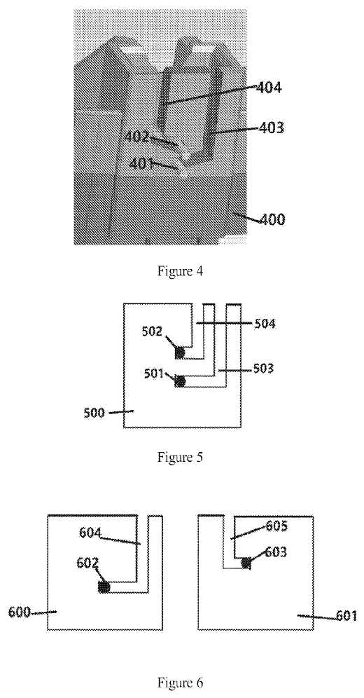

FIG. 4 is an example connecting device incorporating teachings of the present disclosure. There are two slots, a lower slot 403 and an upper slot 404, in an outlet panel of a supporting board 400. The lower slot 403 holds a first stator wire 401 and the upper slot 404 holds a second stator wire 402. Specifically, the first stator 401 wire is at a terminal section of the lower slot and the second stator 402 wire is at a terminal section of the upper slot. Furthermore, the first stator wire 401 enters the chamber before the second stator wire 402 and the first stator wire 401 has an up and down layout with the second stator wire 402. The terminals of the two slots can hold the first stator wire and the second stator wire separately and keep the first stator wire and the second stator wire in an up and down layout. This two slots design improves the reliability of the connection of the stator wires for the motor.

The lower slot 403 has a first direction and the upper slot 404 has a second direction. The two directions are on the opposite sides of the inlet panel, with the same pattern in the outlet panel. Specifically, the terminal section of the lower slot 403 is aligned vertically with the terminal section of the upper slot 404. Furthermore, there is no limitation on the shape of the lower slot 403 and the upper slot 404 in the outlet panel, as long as the up and down layout of the first stator 401 and the second stator 402 can be guaranteed.

The width of the terminal section of the lower slot 403 and the upper slot 404 is determined by the maximum diameter of the stator wires for a series of motors. For example, if the range of the diameters of the stator wires used for a series of motors is from 0.1 mm to 0.3 mm, the width of the terminal section of the lower slot 403 and the upper slot 404 is set to be 0.3 mm. Therefore, the supporting board 400 is suitable for a series of motors of a specific product. All stator wires for the same series of motors can be inserted into the lower slot 403 and the upper slot 404 completely. In this way, the connecting device is suitable for the connection of a series of stator wires with different diameters and the production cost of the supporting boards and the connecting devices can be reduced.

In some embodiments, an additional clamping device can be applied to firmly fix the first stator wire 401 and the second stator wire 402 in the terminals of the lower slot 403 and the upper slot 404, respectively. In this way, when pressing the mag mate, the up and down layout of the first stator wire 401 and the second stator wire 402 can still be guaranteed. The reliability of the connection of the stator wires for the motor can be improved.

FIG. 5 is another example connecting device incorporating teachings of the present disclosure. There are two slots, a lower slot 503 and an upper slot 504, in an outlet panel of a supporting board 500. The lower slot 503 holds a first stator wire 501 and the upper slot 504 holds a second stator wire 502. Specifically, the first stator 501 wire is at a terminal section of the lower slot and the second stator 502 wire is at a terminal section of the upper slot. Furthermore, the first stator wire 501 enters the chamber before the second stator wire 502 and the first stator wire 501 has an up and down layout with the second stator wire 502. The terminals of the two slots can hold the first stator wire and the second stator wire separately and keep the first stator wire and the second stator wire in an up and down layout. This two slots design improves the reliability of the connection of the stator wires for the motor.

The lower slot 503 has a first direction and the upper slot 504 has a second direction. The two directions are on the same sides of the inlet panel, with the same pattern in the outlet panel. Specifically, the terminal section of the lower slot 503 is aligned vertically with the terminal section of the upper slot 504. Furthermore, there is no limitation on the shape of the lower slot 503 and the upper slot 504 in the outlet panel, as long as the up and down layout of the first stator 501 and the second stator 502 can be guaranteed.

The width of the terminal section of the lower slot 503 and the upper slot 504 is determined by the maximum diameter of the stator wires for a series of motors. For example, if the range of the diameters of the stator wires used for a series of motors is from 0.1 mm to 0.3 mm, the width of the terminal section of the lower slot 503 and the upper slot 504 is set to be 0.3 mm. Therefore, the supporting board 500 is suitable for a series of motors of a specific product. All stator wires for the same series of motors can be inserted into the lower slot 503 and the upper slot 504 completely. In this way, the connecting device is suitable for the connection of a series of stator wires with different diameters and the production cost of the supporting boards and the connecting devices can be reduced.

In some embodiments, an additional clamping device can be applied to firmly fix the first stator wire 501 and the second stator wire 502 in the terminals of the lower slot 503 and the upper slot 504, respectively. In this way, when pressing the mag mate, the up and down layout of the first stator wire 501 and the second stator wire 502 can still be guaranteed. The reliability of the connection of the stator wires for the motor can be improved.

FIG. 6 is another example connecting device incorporating teachings of the present disclosure. There are two slots, a lower slot 604 and an upper slot 605, in an inlet panel 600 and an outlet panel 601 of a supporting board, respectively. The lower slot 604 holds a first stator wire 602 and the upper slot holds a second stator wire 603. Specifically, the first stator wire 602 is at a terminal section of the lower slot and the second stator 603 wire is at a terminal section of the upper slot. Furthermore, the first stator wire 602 enters the chamber before the second stator wire 603 and the first stator wire 602 has an up and down layout with the second stator wire 603. The terminals of the two slots can hold the first stator wire and the second stator wire separately and keep the first stator wire and the second stator wire in an up and down layout. This two slots design improves the reliability of the connection of the stator wires for the motor.

The lower slot 604 has a first direction and the upper slot 605 has a second direction. In some embodiments, the two directions can be on the opposite sides or the same sides of the inlet panel 600, with a different pattern in the outlet panel 601. Specifically, the terminal section of the lower slot 604 is aligned vertically with the terminal section of the upper slot 605. Furthermore, there is no limitation on the shape of the lower slot 604 and the upper slot 605 in the inlet panel 600 and the outside panel 601, as long as the up and down layout of the first stator 602 and the second stator 603 can be guaranteed. The width of the terminal section of the lower slot 604 and the upper slot 605 is determined by the maximum diameter of the stator wires for a series of motors. For example, if the range of the diameters of the stator wires used for a series of motors is from 0.1 mm to 0.3 mm, the width of the terminal section of the lower slot 604 and the upper slot 605 is set to be 0.3 mm. Therefore, the supporting board is suitable for a series of motors of a specific product. All stator wires for the same series of motors can be inserted into the lower slot 604 and the upper slot 605 completely. In this way, the connecting device is suitable for the connection of a series of stator wires with different diameters and the production cost of the supporting boards and the connecting devices can be reduced.

In some embodiments, an additional clamping device can be applied to firmly fix the first stator wire 602 and the second stator wire 603 in the terminals of the lower slot 604 and the upper slot 605, respectively. In this way, when pressing the mag mate, the up and down layout of the first stator wire 602 and the second stator wire 603 can still be guaranteed. The reliability of the connection of the stator wires for the motor can be improved.

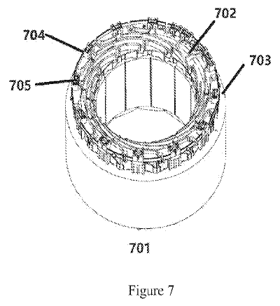

FIG. 7 is another example connecting device incorporating teachings of the present disclosure in a motor. The motor 701 includes a set of stator cores 702, a stator housing 703, a set of supporting boards 704, and a set of mag mates 705. The stator cores 702 is used to hold stator windings in place. The stator housing 702 is used to hold the stator assembly.

With reference to FIG. 1 and FIG. 4, each of the supporting boards 704 include a chamber 101, an outlet panel 103, an inlet panel 104, inlet spacing 105, and outlet spacing 106. Either the inlet spacing 105 or the outlet spacing 106 can be a lower slot 403 or an upper slot 404. The lower slot 403 is designed to hold a first stator wire 401 and the upper slot 404 is designed to hold a second stator wire 402. Specifically, the first stator 401 wire is at a terminal section of the lower slot and the second stator 402 wire is at a terminal section of the upper slot. The first stator wire 401 has an up and down layout with the second stator wire 402 in the chamber 101. The mag mate 705 is applied to cut the insulation of the first stator wire 401 and the second stator wire 402 broken and to make the first stator wire 401 and the second stator wire 402 connected in the up and down layout.

Furthermore, the number of the supporting boards 704 needed for a series of motors is determined by the specific product. The supporting boards 704 can be designed as an independent part. When the supporting boards 704 are applied in the scenario of the embodiment shown in FIG. 7, the fourteen independent supporting boards are assembled. Optionally, the twelve supporting boards can be designed as a whole and applied to the motor as a single part.

The teachings of the present invention include motors and connecting devices for connection of stator wires for a motor. An example connecting device includes: a supporting board includes a chamber; a lower slot and an upper slot, the lower slot configured to hold a first stator wire and the first stator wire is at a terminal section of the lower slot, the upper slot configured to hold a second stator wire and the second stator wire is at a terminal section of the upper slot, and the first stator wire has an up and down layout with the second stator wire in the chamber; and a mag mate configured to cut the insulation of the first stator wire and the second stator wire broken and to make the first stator wire and the second stator wire connected in the up and down layout. The design of the lower slot and the upper slot of the connecting device improves the reliability of the connection of the stator wires for the motor. In the meantime, the width of the terminal section of the lower slot and the terminal section of the upper slot is the maximum diameter of the stator wires for a series of motors; therefore, one design of the connecting device is suitable for the connection of a series of stator wires with different diameters. This solution reduces the production cost of the connecting device.

The teachings have been described in detail above through the accompanying drawings and example embodiments, however, the scope of the present disclosure is not limited to these embodiments, and other solutions derived therefrom by those skilled in the art also fall within the protection scope of the present disclosure.

What is claimed is:

1. A connecting device for connection of stator wires for a motor, the device comprising:
a supporting board including a chamber, a lower slot, and an upper slot, wherein the lower slot is configured to hold a first stator wire at a terminal section of the lower slot, the upper slot is configured to hold a second stator wire at a terminal section of the upper slot, and the first stator wire and second stator wire have an up and down layout in the chamber; and
a mag mate to pierce the insulation of the first stator wire and the second stator wire and electrically connect the first stator wire to the second stator wire in the up and down layout.

2. The connecting device of claim 1, wherein a width of the terminal section of the lower slot and a width of the terminal section of the upper slot are equivalent to a maximum diameter of the first stator wire and the second stator wire.

3. The connecting device of claim 1, wherein;
the lower slot is oriented in a first direction and the upper slot is oriented in a second direction; and
the first direction and the second direction are equivalent directions or opposite directions.

4. The connecting device of claim 1, wherein the terminal section of the lower slot is aligned vertically with the terminal section of the upper slot.

5. The connecting device of claim 1, wherein the chamber is configured to support the mag mate with the first stator wire and the second stator wire.

6. The connecting device of claim 1, wherein the chamber further comprises:
an inlet panel configured to define an inlet spacing, between the first stator wire and the second stator wire entering into the chamber;
an outlet panel configured to define an outlet spacing between the first stator wire and the second stator wire exiting the chamber; and
a surface protrusion.

7. The connecting device of claim 6, wherein the lower slot and the upper slot are located in the inlet panel or the outlet panel.

8. The connecting device of claim 6, wherein the surface protrusion supports the first stator wire and the second stator wire.

9. (canceled)

10. The connecting device of claim 1, wherein the first stator wire and the second stator wire both comprise copper (Cu) or aluminum (Al) wire and are both coated with insulation.

11. The connection device of a claim 1, wherein the mag mate is made comprises a metal.

12. A motor comprising:
a stator core to hold stator windings;
a housing to hold the stator assembly;
a supporting board comprising a chamber, a lower slot, and an upper slot;
wherein the lower slot holds a first stator wire at a terminal section of the lower slot,
the upper slot holds a second stator wire at a terminal section of the upper slot; and
the first stator wire has an up and down layout with respect to the second stator wire in the chamber; and
a mag mate to cut through insulation of the first stator wire and the second stator wire and electrically connect the first stator wire to the second stator wire.

13. The motor of claim 12, wherein a width of the terminal section of the lower slot and a width of the terminal section of the upper slot are equivalent to a maximum diameter of the stator wires.

14. The motor of claim 12, wherein the lower slot has a first orientation and the upper slot has a second orientation, the first orientation and the second orientation are of same direction or opposite directions.

15. The motor of claim 12, wherein the terminal section of the lower slot is aligned vertically with the terminal section of the upper slot.

16. The motor of claim 12, wherein the chamber supports the mag mate with the first stator wire and the second stator wire.

17. The motor of claim 12, wherein the chamber further comprises:
an inlet panel defining an inlet spacing for the first stator wire and the second stator wire entering into the chamber;
an outlet panel defining an outlet spacing for the first stator wire and the second stator wire exiting the chamber; and
a surface protrusion.

18. The motor of claim 12, wherein the lower slot and the upper slot are located in the inlet panel or the outlet panel.

19. The motor of claim 12, wherein the surface protrusion supports the first stator wire and the second stator wire.

20. (canceled)

21. The motor of claim 12, wherein the first stator wire and the second stator wire both comprise copper (Cu) or aluminum (Al) wire and are both coated with insulation.

22. The motor of claim 12, wherein the mag mate comprises metal.
